(19) United States
(12) Patent Application Publication
(10) Pub. No.: US 2005/0072292 A1
(43) Pub. Date: Apr. 7, 2005

(54) Stringed instrument instructional aid for locating finger placement for guitar and bass musical scales

(76) Inventors: Jason Richard Ellestad, Houston, TX (US); Mark Jonathan Peoples, Houston, TX (US)

Correspondence Address: Mr. Jason R. Ellestad, 9243 Chester Park Drive, Houston, TX, 77064, US

(21) Appl. No.: 10/675,124

(22) Filed: Oct. 1, 2003

(51) Int. Cl. G09B 15/00

(52) U.S. Cl. 84/485 R

(57) ABSTRACT

An composition exhibiting a desired value of magnetic susceptibility, which can be used to fabricate components in an NMR device, and method thereof, wherein the composition comprises a metal ion selected from the group consisting of Gd⁺³, Fe⁺³ and Mn⁺² and an amorphous material using a ligand or chelating agent to solubilize the metal ion throughout the marphous material, wherein the magnetic susceptibility of the composition exhibits a desired value at cryogenic temperatures such as nearly zero susceptibility at temperatures at or below 77° K.

### REFERENCES CITED

U.S. Patent Documents

| | | |
|---|---|---|
| 3572205 | July 1969 | Scholfield |
| 3748947 | July 1973 | Frieheit |
| 4175468 | November 1979 | Whitlock |
| 4314499 | February 1982 | Olsen |
| 4537111 | August 1985 | Heath |
| 4559861 | December 1985 | Patty |
| 4712464 | December 1987 | Nance |
| 5386757 | February 1995 | Derrick |
| 5594191 | January 1997 | Epstein |
| 5920023 | July 1999 | Ravagni et al. |
| 6162981 | December 2000 | Newcomer |
| 6191348 | February 2001 | Johnson |
| 6452081 | September 2002 | Ravagni |

### FIELD OF THE INVENTION

The present invention relates to a system to aid in instructing finger placement on the fingerboard of conventional guitars and basses for the purpose of learning and playing musical scales in different keys. This invention is geared towards guitar and bass players who want to memorize a variety of scales in every key. The advantage to this invention is that each scale strip is designed to show only the notes and finger positions that are comprised in that particular scale. As a result, that player is able to enjoy improvisational playing with rhythm machines or “play along tapes and compact discs”, songs, and/or desire to improve their soloing skills.

### BACKGROUND OF THE INVENTION

Learning musical scales is a tedious and frustrating ordeal. There are many varieties of musical scales and the keys to play them in. It can and usually takes a guitarist a long time to master one scale and to become comfortable with all the possible locations on the instruments fret board. A guitarist relies on “Fret board Visualization.” Fretboard Visualization is when a player becomes familiar with the notes within in a particular scale at a particular location on the fingerboard through repetition and practice. If the guitarist wishes to play the same scale but in a different key, then the locations change. The player now has to recommit to memory the new locations on the fingerboard, thus adding confusion and reducing play efficiency. Scale shapes are universal and what dictates the location of where these scales are played is the scale's musical key. A number of devices have been patented to aid in learning the fret board and the eligible notes that can comprise a particular musical scale, but unfortunately all of these devices have disadvantages when trying to single out all of the notes in a particular scale and or key:

U.S. Pat. No. 5,594,191 to Epstein describes an instruction element that is comprised of polyvinyl chloride, is transparent, and is adhered adjacent to backside of the neck adjacent to the fingerboard via electrostatic interaction. One disadvantage of this invention is that you are limited in length of the aid when applying to the neck since the body of the bass or guitar will restrict the element from spanning to the frets nearest the end of the fingerboard. Another problem is the possibility of the actual width required to ensure legible information is provided on this invention may force the student to have to slightly “roll” the instrument away from him or her in order to read all of the invention's information. Another negative aspect is that over time, constant friction from the fretting hand rubbing the back of the neck, as well as the presence of body sweat and oils, may possibly rub off the information rendering it non-useful. Due to the invention's transparent nature, one major drawback is that if any colors that are infused in the invention for the purpose of indicating notes, chords, or scales happen to match the colors of the finish on the neck of the fretted instrument, the student may have difficulties in trying to interpret the intended information.

U.S. Pat. No. 6,162,981 to Newcomer, which relies on a finger sensor apparatus has disadvantages due to the fact the student must be bound to an area that needs to satisfy all requirements of: 1) access to a computer 2) working electricity or batteries, and 3) reasonable environment to practice with this device. Another drawback is a device like this can be expensive and difficult to understand. This is also apparent with U.S. Pat. No. 6,191,348 to Johnson and U.S. Pat. No. 6,452,081 to Ravagni, which requires outside electrical or battery operated devices to work in conjunction with their inventions, thus limiting to students who only have these means available, and thus creating a restricted environment in order to use these inventions.

U.S. Pat. No. 4,712,464 to Nance discloses a finger-positioning guide including a flat surface, which is positioned on the surface of the fingerboard between the neck and strings of a fretted stringed instrument. This comprises of a mechanical device located on the surface of the fingerboard and beneath the strings. Uniformly colored dots on the invention are at coordinated distances along the neck to enable a guitarist to know which notes comprises a particular chord. The flat surface of the invention is positioned in relation to the neck and the strings by a plurality of slots adapted for engaging the frets and nut of the fingerboard. There are similarities with Nance's overall intent and general concept and with U.S. Pat. No. 5,920,023 to Ravagni. One major problem with these patented devices are that the player has to know which notes make up a particular chord or scale in order to locate their position on the fingerboard. Another drawback is player confusion due to a series of multiple notes that do not apply to the scale the player is wishing to learn. These patented devices are very tedious in applying because of having to carefully slide the material beneath the strings and the fingerboard. The player may become frustrated with the amount of time it will take to insert these learning devices correctly. As a result, the player will become locked into a particular musical key and may find it unattractive to play in other musical keys due to the required time and difficulty it takes to install these inventions. U.S. Pat. No. 5,920,023 to Ravagni, relies on a self-adhering plastic sheeting such as “Cling Vinyl for the invention which may prematurely adhere to the fingerboard and/or neck before achieving the necessary results to be considered “final installation”. Another drawback is that these devices are limited to a portion of the fretted instrument's neck and fingerboard and not the entire neck and fingerboard thus eliminating a broad number of notes, including octaves. As a result, this poses design limitations due to that particular fretted instrument's neck scale length.

U.S. Pat. No. 5,386,757 to Derrick uses a universal musical scale, scale pattern, and chord indicator by means of a housing of slide-rule nature. Unfortunately this learning devices in not located on the fretted instruments fingerboard or neck and thus is not in the sight line of the player's eyes at all time.

U.S. Pat. No. 3,572,205 to Scholfield describes a musical teaching device that transposes notes in one musical key to the corresponding notes of any other key by means of dialing a series of concentrated disks. The main disadvantage of this device is that it is not located on the fret board and thus is not in the sight line of the player's eyes at all times. As a result, the guitar player becomes distracted by having to repeatedly look back at the information, therefore loosing focus and concentration. This distraction is also true of all scale books and videos where the player has to distract his eyes temporarily in order to look at the information that is somewhere else away from the fret board. Another negative aspect is the device is difficult to utilize and understand.

U.S. Pat. No. 3,748,947 to Frieheit describes a melody chord constructor with symbols denoting the instrument's musical notes, which are arranged in rows and columns corresponding to the fingerboard's strings and frets. The main problem is that this device is outdated and difficult to utilize and understand.

U.S. Pat. No. 4,175,468 to Whitlock, U.S. Pat. No. 4,314,499 to Olsen, U.S. Pat. No. 4,537,111 to Heath, and U.S. Pat. No. 4,559,861 to Patty are all teaching devices that are too complex in construction and confusing. As a result, there is less incentive for a player to play their musical scales due to these tedious guitar aids.

### SUMMARY OF THE INVENTION

The present invention relates to a system to aid in instructing finger placement on the fingerboard of conventional guitars and basses for the purpose of learning and playing musical scales in different keys. This invention is geared towards guitar and bass players who want to memorize a variety of scales in every key. This invention will be used to teach a student by means of an instructional aid located on the top of the guitar neck, adjacent to the fingerboard enabling a student to play a variety of musical scales in every key. This finger-positioning tool is comprised of two magnetic and/or magnetically-type receptive material strips. The “base” strip is a flexible ferrous magnetically receptive material with an adhesive backing that will adhere to the top of the fretted instrument's neck, adjacent to the fingerboard spanning from the instrument's nut to the end of the fingerboard. This “base” strip may be easily removed when play is completed, and then reapplied when needed or can be left attached to the neck if desired. Thus, the “base” strip of the present invention is removable from the neck, and may be reused.

The “base” strip accepts the second magnetic strip known as the “scale strip. The “scale” strip is of flexible magnetic material which has the fret mark indicators, letters and/or Roman numeral numbers that have been color coded specifically to indicate correct finger location for that particular scales' key, a 12^{th} fret location indicator to properly install the strip, listed notes per that scale, the specific key(s) that particular scale strip represents, and the neck scale length indicator to ensure the player has the correct scale strip to fit to the guitar's neck specifications.

Thus, it is an object of the present invention to provide a device for teaching students of a guitar or bass proper finger locations on the fingerboard of a stringed instrument for the purpose of playing musical scales in any key.

It is a further object of the present invention to provide a device for teaching students finger locations on the fingerboard of a guitar or bass wherein the device is removably attached to the top of the neck of the instrument.

It is a further object of the present invention to provide a device for teaching students of a guitar or bass finger locations on the fingerboard of the stringed instrument wherein the device requires no cling vinyl, tape, plastic, matching hook and loop type fastener commonly sold under the trademark “Velcro or mechanical means to attach the device to the stringed instrument.

It is also an object of the present invention to provide a device for teaching musical scale locations on the fingerboard of a guitar or bass wherein the device is adhered on the top of the neck adjacent to the fingerboard and does not interfere with play of the instrument.

It is a further object of the present invention to provide a device for teaching students of a guitar or bass to efficiently play and memorize scales in every key.

It is yet another object of the present invention to provide a device for teaching students of a guitar or bass to encourage the development of proper intonation.

These features and advantages of the present invention will be better understood from the following detailed description with the following accompanied drawings of the invention are illustrated by way of example. It is to be stipulated that the drawings are for purposes of illustration and description only, and are not intended as a definition of the limits of the invention.

### BRIEF DESCRIPTION OF THE DRAWINGS

FIG. 1 is a two-dimensional plan view of the fmger positioning tool known as the “base” strip of the present invention suitable for use with a fretted stringed, either a bass or guitar.

FIG. 2 is a two-dimensional plan view of the finger-locating tool known as the “scale” strip of the present invention suitable for use with a fretted stringed, either a bass or guitar.

FIG. 3 is a cross sectional view demonstrating the application of the “base” strip of the present invention to top of the neck, adjacent to the fingerboard of an electric guitar.

FIG. 4 is a cross sectional view demonstrating application and attachment of the “scale” strip of the present invention to the “base” strip which is already attached to the top of the neck, adjacent to the fingerboard of an electric guitar.

FIG. 5 is an isometric view of the finished application of both the “base” and “scale” strip.

### DETAILED DESCRIPTION OF THE INVENTION

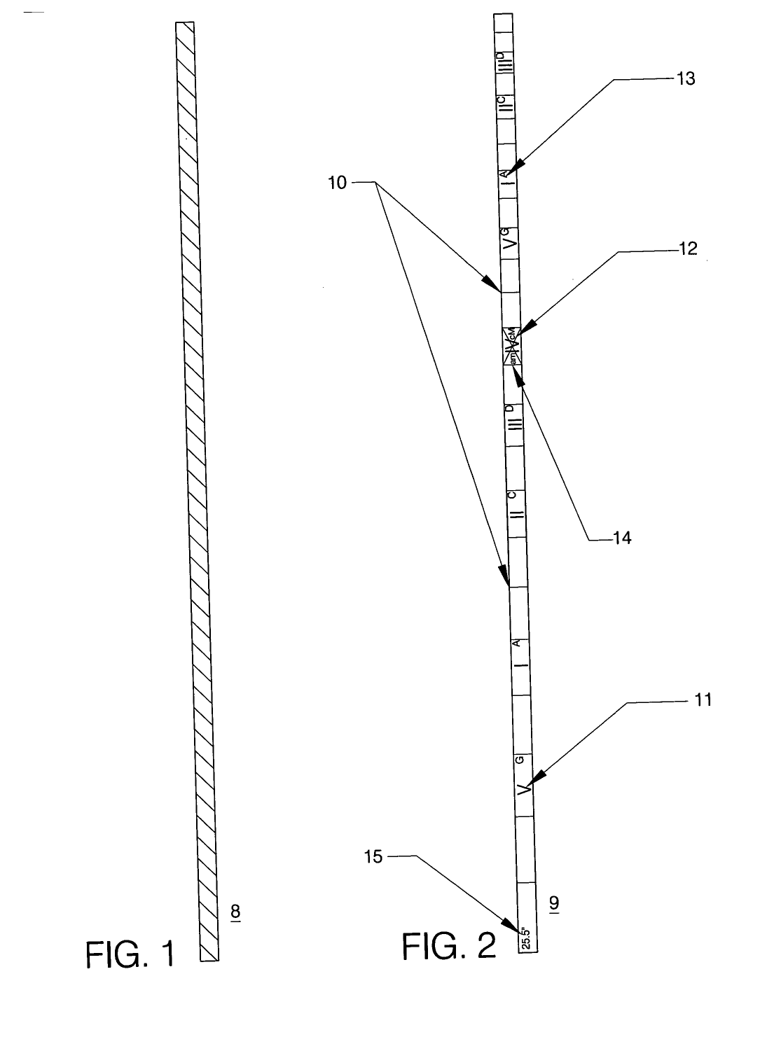

With reference to FIG. 1 and FIG. 3 of the present invention comprises a flexible ferrous magnetically receptive material that is cut into a 3/16″ wide strip known as the “base” strip 8 and has an adhesive backing that will adhere to the top of the fretted instrument's neck 5, adjacent to the fingerboard spanning from the instrument's nut 6 to the end of the fingerboard 7. The guitar or bass's neck 5 shall be clean and dry prior to the “base” strip application to ensure a good contact between the adhesive surface and the neck of the instrument.

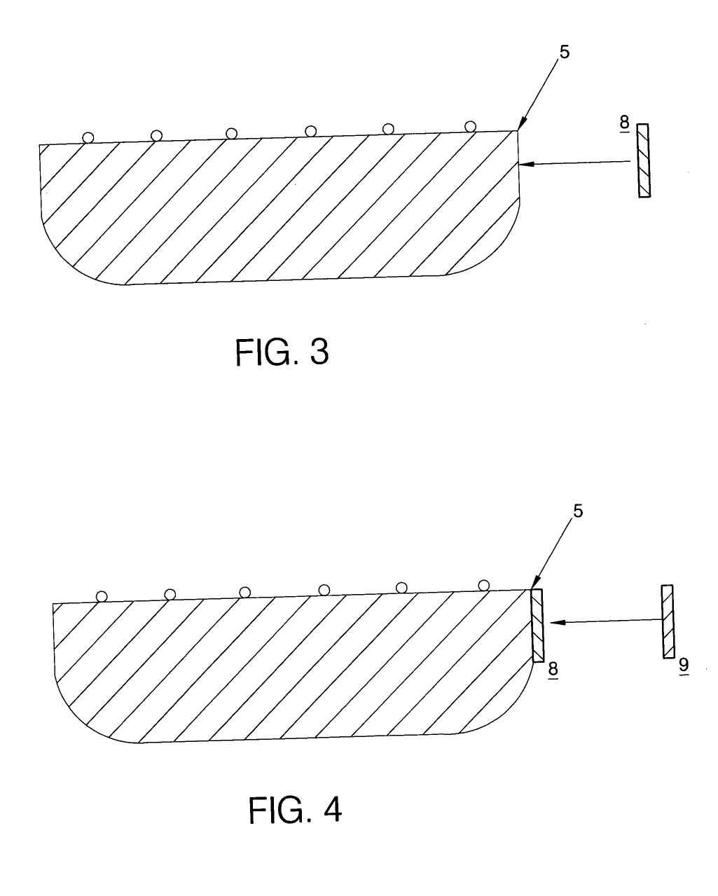

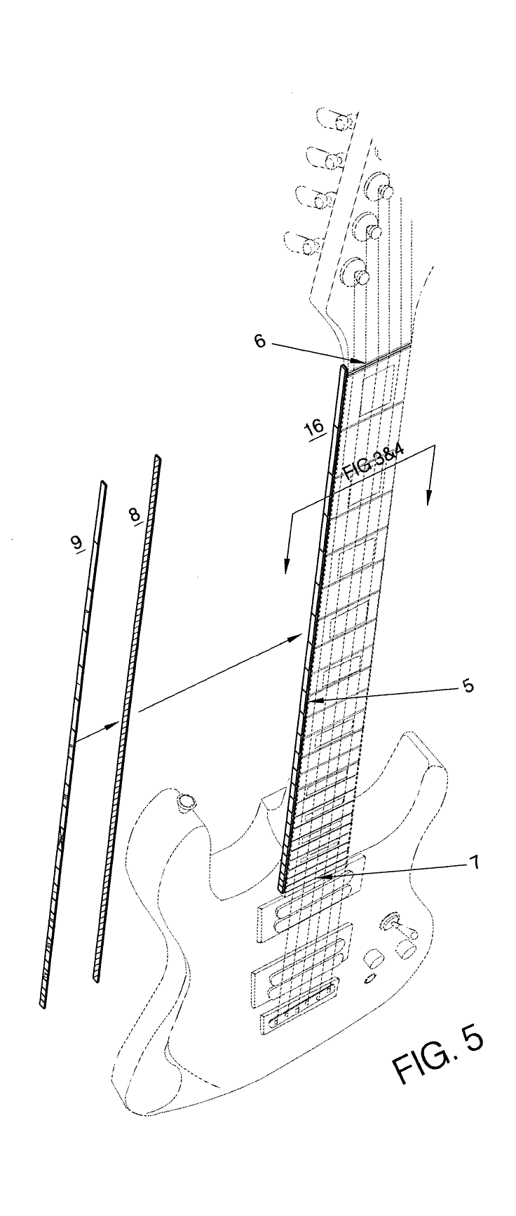

With reference to FIG. 2 and FIG. 4 of the present invention comprises of flexible magnetic material that is cut into a 3/16″ wide strip known as the “scale” strip 9 spanning from the instrument's nut 6 to the end of the fingerboard 7 which has the fret mark indicators 10 letters and/or Roman numeral numbers that have been color coded specifically to indicate correct finger location for that particular scales' key 11, a 12^{th} fret location indicator to properly install the strip 12, listed notes per that scale 13, the specific key(s) that particular scale strip represents 14, and the neck scale length indicator to ensure the player has the correct scale strip to fit to the guitar's neck specifications 15. The “scale” strip is attached to the “base” strip by means of the magnetic interaction between the two materials 16.

The criteria and purpose for selecting the colors for the “scale” strip is to assign them to a specific Roman numeral number for a pentatonic scale (for example) or an abbreviated word for a major scale (for example). This consistent color code system will be associated with that same number or word for all possible scale strips. This will enable the student to associate a color with a particular scale position and the consistency of this logic and legend will be maintained for all of the scale strips.

The “base” strip 8 of the present invention is constructed from a flexible ferrous magnetically receptive material with an adhesive backing. One presently preferred magnetically receptive material for constructing the “base” strip 8 for the present invention is FLEXIRON manufactured by Master Magnetics Inc. of Castle Rock, Colorado. This type of magnetically receptive material has the characteristics of a flexible magnet but does not have polarity fields that occur in magnets and thus the “base” strip 8 will not repel the “scale” strip 9. The “base” strip 8 is approximately 0.025″ thick and 3/16″ wide.

The width and thickness of the “base” strip 8 being used is significant because it must not be wide enough to interfere spanning the entire neck 5 of the fingerboard and thick enough to have a strong attraction with the “scale” strip 9.

The “scale” strip 9 of the present invention is constructed from flexible magnetic material with an adhesive backing to which the printed information will be adhered. One presently preferred magnetic material for constructing the “scale” strip 9 for the present invention is ZIPGRIP manufactured by Master Magnetics Inc. of Castle Rock, Colorado. The “scale” strip 9 is approximately between 0.030″ and 0.060″ thick and 3/16″ wide and has approximately between 85 to 145 pounds of pull per square foot indicated in the product's specifications.

The fret mark indicators 10 letters and/or Roman numeral numbers that have been color coded specifically to indicate correct fmger location for that particular scales' key 11 a 12^{th} fret location indicator to properly install the strip 12, listed notes per that scale 13 the specific key(s) that particular scale strip represents 14, and the neck scale length indicator to ensure the player has the correct scale strip to fit to the guitar's neck specifications 15 will be applied to high quality photo gloss paper from a plotting or printing device using any type of permanent ink. One present paper is manufactured from Hewlett Packard Company in which it is a high quality photo gloss paper with the specifications of: a thickness of 7 mil., print material brightness of 90 per tappi, opacity of 93%, and a print material smoothness of 10 per tappi. It is important that the inks be capable of permanently adhering to the gloss paper so that they are not easily smeared or worn away with use. To further prevent such occurrence, a clear acrylic protective coating shall be applied for the present invention, which is No. 201 Plastic Spray, manufactured by Sprayway of Addison, Illinois. This clear acrylic protective coating prevents yellowing or smudging, is highly flexible, water-repellent, and safe to be used on colored ink. Another option is to use the ZIPGRIP magnetic product with vinyl already adhered to the product. From there, permanent inks can be plotted on the vinyl directly. This vinyl product will not be transparent and will not have any “clinging” characteristics.

With reference to FIG. 3 and FIG. 5, the “base” strip 8 of the present invention is applied and retained to the guitar or bass's top of neck 5 by means from the adhesive backing. Prior to applying base” strip 8 it is advisable to clean and thoroughly dry the fingerboard and neck with an acceptable instrument cleaning solution to ensure better contact.

With reference to FIG. 4 and FIG. 5, the “scale” strip 9 is applied directly to the “base” strip 8 using the a 12^{th} fret location indicator 12 and making certain the player has the correct set of “scale” strips that match the guitar or bass's neck scale length by means of the neck scale length indicator 15 to ensure the player has the correct scale strip to fit to the instrument's neck specifications.

To remove the “scale” strip 9 from the “base” strip 8, just peel off the strip. To remove the “base” strip 8, carefully peel off the strip with a vertical removal action in lieu of back and forth motion to reduce or prohibit the loss of adhesive which is on the back of the “base” strip 8. If there is need to clean the top of the instrument's after removable of “base” strip, using a dry-damp cloth with an acceptable instrument cleaning solution. This present invention is reusable and may also be transferred to different instruments of the same type and similar size.

The present invention is geared towards guitar and bass players who want to memorize a variety of scales in every key. The advantage to this invention is that each scale strip is designed to show only the notes and finger positions that are comprised in that particular scale. As a result, the player is able to enjoy improvisational playing along with rhythm machines or “play along tapes and compact discs”, songs, accelerate learning, and/or desire to improve their soloing skills.

To manufacture the finger positioning guide of the present invention for use with guitars and bass instruments, fret distances were calculated for various but common neck scale lengths of guitars and basses. Using the calculated distances between the frets for each particular neck scale length, a 3/16″ wide by a calculated length of particular fingerboard was drawn on a computer, which was to be used as a template for designing the “scale” strips.

While the preferred embodiments of the present invention have been illustrated and described, it will be appreciated that those skilled in the art, upon consideration of the present disclosure, may make modifications and/or improvements can be made therein without departing from the spirit and scope of the invention as set forth and defined in the following claims.

1. A finger positioning guide for finger placement used by a player for a guitar or bass having a elongated neck, said neck having a top side and a plurality of strings and frets along a fingerboard placed on the top side of the neck comprising:
A. a “base” strip having a length and width of flexible ferrous magnetically receptive material element with or without magnetic polarity and self-adherent by means of adhesive backing attached to the top side of the neck adjacent to the fingerboard spanning across the entire length of the fingerboard.
B. An overlaying strip that will cover the “base” strip as indicated in claim 1A having a length and width of flexible magnetic material with or without magnetic polarity with denoted information to play musical scales of different keys that are capable of being sounded by the instrument when a string depression is made at a corresponding location on the fingerboard.
C. Said strip in claim 1B having at least one finger-positioning marker.

2. The guide of claim 1 further comprising a plurality of finger positioning markers for the purpose of sounding musical scales by means of showing only the notes and finger positions that are comprised in that particular scale.

3. The finger positioning markers of claim 2 further comprising of markers having annotation for indicating the finger position and note, said annotation is at least one means selected from the group comprising color, letter, and number.

4. Printed material adhered to magnetic strip material of claim 1B of the instruction element may be comprised of paper, high quality photo, glossy, matte paper and/or laminated vinyl.

5. Printed material of claim 4 shall not be transparent and shall not be comprised of polyvinyl chloride for such purpose as to act as “cling vinyl”.
